(19) United States
(12) Patent Application Publication
(10) Pub. No.: US 2006/0181197 A1
(43) Pub. Date: Aug. 17, 2006

(54) Electroluminescent device and display

(76) Inventors: Kumio Nago, Nara (JP); Masaru Odagiri, Hyogo (JP); Masayuki Ono, Osaka (JP); Kenya Hori, Okayama (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 10/562,791

(22) PCT Filed: Jul. 1, 2004
(86) PCT No.: PCT/JP04/09673

§ 371 Date: Dec. 29, 2005

(51) Int. Cl. H01J 1/62

(52) U.S. Cl. 313/503

(57) ABSTRACT

An electroluminescent element includes a pair of positive electrode and negative electrode facing each other, and at least one phosphor layers formed between the pair of positive electrode and negative electrode. At least one of the phosphor layers is composed of a phosphor layer and a wide band-gap semiconductor layer. The semiconductor layer or the phosphor layer constituting the phosphor layer may be a partially discontinuous layer.

### BACKGROUND

1. Technical Field

The present invention relates to electroluminescent elements used for a planar light source and a flat display device.

2. Description of the Related Art

Conventional light emitting devices, used for planar light sources and flat display devices, use light emitting diodes or electroluminescent elements (referred to as EL elements).

Light emitting diodes are advantageous in high brightness and high luminous efficiency. However, they must be formed on a compound semiconductor substrate, and it is difficult to increase the size of one semiconductor substrate. Further, in order to increase the size of a flat display device, a large number of light emitting diodes must be arranged in two dimensions.

The structure of an EL element will be explained by using FIG. 5. FIG. 5 is a cross-sectional view showing the structure of an EL element. An EL element 50 has a cell structure in which a phosphor layer 54 is interposed between electrodes 52 and 55. As shown in FIG. 5, the electrode 52, an insulating layer 53a, the phosphor layer 54, an insulating layer 53b and the electrode 55 are formed in sequence on a substrate 51. The phosphor layer 54 consists of a phosphor such as ZnS, and has a thickness of 0.5 μm to 1 μm, for example. Further, at the outside of the EL element 50, an AC source 56 is connected between the electrode 52 and the electrode 55. By applying a voltage between the electrode 52 and the electrode 55 by the AC source 56, the EL element 50 emits light. The EL element 50 is less subject to the restriction for the material of the substrate 51, so it is possible to increase the size with a single substrate.

### SUMMARY

However, in order to increase the size of a planar light emitting device using the light emitting diodes described above, a number of light emitting diodes are required. This causes a problem of an increase in the manufacturing cost in proportion to the number of elements.

Further, a planar light emitting device using the EL elements described above has no problem in increasing the size, and is more advantageous than other displays in such points as thin shape, high-speed response, large viewing angle, and high contrast. However, the luminous efficiency and brightness are low, and the lifetime is as short as about ten thousands hours, so there are shortcomings practically. Further, it is required to apply an AC voltage of several hundreds V in a high frequency of several kHz generally. Therefore, it is difficult to perform a drive of active matrix type using general purpose thin film transistors, causing a problem that the cost of driving circuit increases.

Further, in an inorganic phosphor such as CaS:Eu or Y₂O₃:Mn typically used for an EL element, a luminescence center of a transition metal such as Mn or a rear earth metal such as Eu is added in an inorganic compound crystal such as sulfide including CaS and oxide including Y₂O₃. Therefore, luminescence due to ultraviolet light excitation is realized. On the other hand, an electron is less likely to transmit an inorganic phosphor although an electric field is applied, and an electrification repulsion is strong. Therefore, it is required to excite the luminescence center in the inorganic phosphor by causing a high-speed electron accelerated in the high electric field to collide. Therefore, it is required to apply an AC voltage of several hundreds V in a high frequency of several kHz generally, causing a problem that the cost of the driving circuit increases.

The present invention has been developed in view of such problems. It is therefore an object of the present invention to provide luminescent elements capable of realizing a drive with a low voltage of several V to several tens V (low power consumption), a high luminous efficiency, and an increase in size at low cost.

An electroluminescent element according to the present invention is characterized as to include a pair of electrodes facing each other, and one or a plurality of phosphor layers formed between the pair of electrodes. At least one of the phosphor layers includes a phosphor semiconductor with wide band-gap.

The phosphor layer may have a laminated structure of a phosphor layer and a semiconductor layer with wide band-gap.

Further, the electroluminescent element may further include at least one transparent conductive layer interposed between the pair of electrodes. The transparent conductive layer may be a partially discontinuous layer.

Further, at least one of the phosphor layer and the semiconductor layer constituting the phosphor layer may be a partially discontinuous layer. In such a case, any of the following cases is acceptable: both of the semiconductor layer and the phosphor layer are discontinuous layers, the semiconductor layer is a continuous layer and the phosphor layer is a discontinuous layer, the semiconductor layer is a discontinuous layer and the phosphor layer is a continuous layer, and both of the semiconductor layer and the phosphor layer are continuous layers.

Further, the phosphor layer may include phosphor particles, in each of which at least a part of the surface thereof is covered with a semiconductor having a wide band-gap.

Further, the phosphor layer may include phosphor particles in each of which substantially all surface thereof is covered with a semiconductor having a wide band-gap.

Further, the phosphor layer may be so configured that the phosphor particles, in each of which at least a part of the surface thereof is covered with a semiconductor having a wide band-gap, are dispersed in a matrix material.

Further, the phosphor layer may be so configured that the phosphor particles, in each of which substantially all surface thereof is covered with a semiconductor having a wide band-gap, are dispersed in a matrix material.

The matrix material may be a transparent conductor.

Further, it is preferable that the semiconductor included in the phosphor layer have a band-gap causing to emit light of a shorter wavelength region than blue light by applying an electric field. As the semiconductor, a compound semiconductor having a band-gap of 2.0 eV may be used. More preferably, a compound semiconductor having a band-gap of 2.5 eV may be used. For example, any one of the following is more preferable: a 13^{th}-15^{th} group compound semiconductor, a mixed crystal thereof, or a mixtures thereof in which a partial segregation is allowed; a 12^{th}-16^{th} group compound semiconductor, a mixed crystal thereof, or a mixture thereof in which a partial segregation is allowed; a 2^{nd}-16^{th} group compound semiconductor, a mixed crystal thereof, or a mixture thereof in which a partial segregation is allowed; a 12^{th}-13^{th}-16^{th} group compound semiconductor, a mixed crystal thereof, or a mixture thereof in which a partial segregation is allowed; a 11^{th}-13^{th}-16^{th} group compound semiconductor, a mixed crystal thereof, or a mixture thereof in which a partial segregation is allowed; and a 12^{th}-14^{th}-15^{th} group compound semiconductor, a mixed crystal thereof, or a mixture thereof in which a partial segregation is allowed.

Further, in order to improve the flow of electrons within the phosphor layer, it is preferable that an electron transport layer of a metallic complex of 8-hydroxyquinoline such as Alq3, an amorphous material such as BMB-2T of a thiophene compound, or the like be provided between the phosphor layer and at least one of the electrodes.

In order to make a typical EL element emit light, it is necessary to cause a high-acceleration electron to collide with a phosphor so as to cause an electron beam excitation, whereby it is required to apply a high voltage of several hundreds V. On the other hand, in the electroluminescent element of the present invention, a wide band-gap semiconductor layer or a semiconductor cover layer first emits light in an ultraviolet region of the wavelength of 300 nm to 350 nm to a blue green light region of 500 nm band, with a low voltage. More preferably, it emits light in an ultraviolet region of the wavelength of 300 nm to 350 nm to a blue light region of 400 nm band. The phosphor layer or phosphor particles are excited with the light, whereby the phosphor layer emits light as a whole, so high brightness and high luminous efficiency can be obtained. Then, electrons flow into an adjacent transparent conductive layer, to thereby induce the next light emission. Since this light emitting mechanism is repeated, the flow of electrons continues, whereby a low voltage drive (low power consumption) and a long lifetime are realized.

Further, the pair of electrodes may be positive electrode and negative electrode. In such a case, a DC voltage is applied between the pair of positive electrode and negative electrode. Further, at least one semiconductor layer constituting the phosphor layer may be located nearer the negative electrode side than the phosphor layer.

Further, the electroluminescent element according to the present invention may further include a thin film transistor connected with one of the pair of electrodes. In the electroluminescent element of the present invention, it is possible to use a thin film transistor since the driving voltage is as low as several V.

A display device according to the present invention is characterized as to include: an electroluminescent array in which electroluminescent elements are arranged in two dimensions; a plurality of x electrodes, in parallel with each other, extending in a first direction in parallel with a face of the electroluminescent array; and a plurality of y electrodes extending in parallel with a second direction, orthogonal to the first direction, in parallel with the face of the electroluminescent array. The thin film transistor of the electroluminescent array is connected with the x electrode and the y electrode, respectively.

As described above, according to the electroluminescent element of the present invention, a wide band-gap semiconductor performs ultraviolet region luminescence or blue light luminescence with a low voltage, and the phosphor is excited by the short wavelength light thereof, so the phosphor layer emits light as a whole. Therefore, high brightness and high luminous efficiency can be obtained. Further, since the matrix consists of a transparent conductor, the flow of electrons continues, whereby a low voltage drive (low power consumption) and a long lifetime are realized. Further, an increase in size is easily realized, whereby a cost reduction can be achieved.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a cross-sectional view showing the structure of an electroluminescent element according to an embodiment 1 of the present invention;

FIG. 2 is a cross-sectional view showing the structure of an electroluminescent element according to an embodiment 2 of the present invention.

FIG. 3 is a cross-sectional view showing the structure of an electroluminescent element according to an embodiment 3 of the present invention.

FIG. 4 is a cross-sectional view showing the structure of an electroluminescent element according to an embodiment 4 of the present invention.

FIG. 5 is a cross-sectional view showing the structure of a conventional electroluminescent element.

FIG. 6 is a perspective view showing the luminescent element according to an embodiment 5 of the present invention.

FIG. 7 is a planar schematic diagram of a display device using an luminescent element according to an embodiment 6 of the present invention.

FIG. 8 is a cross-sectional view showing the structure of an electroluminescent element according to an embodiment 7 of the present invention.

FIG. 9 is a cross-sectional view showing the sectional structure of a phosphor particle, the substantially whole surface of which is covered with a semiconductor of a wide band-gap, as another example of the embodiment 7.

FIG. 10 is a cross-sectional view showing the configuration of an electroluminescent element according to an embodiment 8 of the present invention.

FIG. 11 is a perspective view showing the electroluminescent element according to an embodiment 9 of the present invention.

FIG. 12 is a planar schematic diagram showing a display device using an luminescent element according to an embodiment 10 of the present invention.

FIG. 13 is a cross-sectional view showing the structure of an electroluminescent element according to an embodiment 11 of the present invention.

FIG. 14 is a cross-sectional view showing the structure of an electroluminescent element according to an embodiment 12 of the present invention.

FIG. 15 is a cross-sectional view showing the structure of an electroluminescent element according to an embodiment 13 of the present invention.

### DESCRIPTION OF THE PREFERRED EMBODIMENTS

Electroluminescent elements according to the present invention will be explained by using accompanying drawings. Note that substantially same members in the drawings are denoted by the same reference numerals.

### Embodiment 1

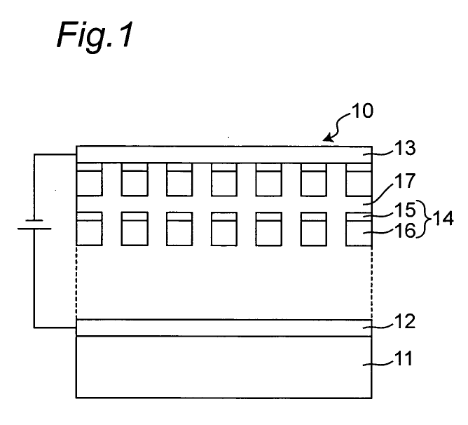

An electroluminescent element according to an embodiment 1 of the present invention will be explained by using FIG. 1. FIG. 1 is a cross-sectional view showing the configuration of an electroluminescent element 10 according to the embodiment 1. The electroluminescent element 10 has a multi-layer structure, in which a pair of positive electrode 12 and negative electrode 13 facing each other is provided on a substrate 11. Further, in between the positive electrode 12 and the negative electrode 13, a phosphor layer 14 consisting of a semiconductor layer 15 and a phosphor layer 16 is laminated repeatedly via a transparent conductive layer 17. The semiconductor layer 15 and the phosphor layer 16 constituting the phosphor layer 14 is a discontinuous layer, in which discontinuous parts between respective phosphor layers 14 are filled with the transparent conductive layer 17. Note that although only two sets of phosphor layers 14 are described in FIG. 1, the present invention is not limited to this configuration. One set or three sets or more phosphor layers 14 may be acceptable. The electroluminescent element 10 emits light by applying a low voltage of several V to several tens V between the positive electrode 12 and the negative electrode 13 by a DC source. Further, the positive electrode 12 is a transparent electrode, and light emitted from the phosphor layer 14 is extracted from the side of the positive electrode 12.

Next, each member constituting the electroluminescent element will be described.

First, the substrate 11 is preferably quartz, glass or ceramic with fine transparency. Further, the positive electrode 12 is formed on the substrate 11. The positive electrode 12 preferably consists of ITO (SnO₂ is doped in In₂O₃) which is a transparent conductor, InZnO, tin oxide, zinc oxide or the like. Further, the negative electrode 13 is provided opposite the positive electrode 12. The negative electrode 13 may be Pt or Ir. Further, a material with low work function such as Al, In, Mg, Ti, MgAg, and AlLi may be used.

In between the positive electrode 12 and the negative electrode 13, the phosphor layer 14 consisting of the semiconductor layer 15 and the phosphor layer 16 is laminated repeatedly via the transparent conductive layer 17. The semiconductor layer 15 and the phosphor layer 16 constituting the phosphor layer 14 are discontinuous layers, in which discontinuous parts between respective phosphor layers 14 are filled with the transparent conductive layer 17.

The transparent conductive layer 17 may be ITO, InZnO or tin oxide. Thereby, it is possible to prevent charging, and to prevent repulsion of subsequent electrons. Further, it is also possible to extract light outside without interrupting the light emitted from the phosphor layer 14. Other preferable examples include metallic oxide such as ZnO, In₂O₃ and Ga₂O₃, and compound oxide including these materials. Further, a transparent conductive resin material may be used as the transparent conductive layer 17. Preferable examples of the transparent conductive resin materials include: polyacetylene series, polyphenylene series such as polyparaphenylene, polyphenylene vinylene, polyphenylene sulfide, and polyphenylene oxide, heterocyclic polimer series such as polypyrrole, polythiophene, polyfuran, polyselenophene and polytellurophene, ionicity polimer series such as polyaniline, polyacene series, polyoxadiazole series, metal phthalocyanine series, polyvinyl series, and their conductive materials, copolymers, and compounds. Further, more preferably, poly-N-vinylcarbazole (PVK), polyethylene dioxythiophene (PEDOT), polystyrene sulfonic acid (PSS), polymethyl phenylsilane (PMPS), poly-[2-methoxy-5-(2-ethyl hexyl oxy)-1,4-(1-cyano vinylene)phenylene] (CN-PPV), poly-quinoxaline may be used. Doping with H₂SO₄ or the like may be performed in order to adjust the conductivity. Further, a form in which a low molecular electron transporting material described later is molecular-dispersed in the conductive resin or nonconductive resin, or a form in which the structure is incorporated in a molecular chain may be acceptable. Moreover, a form in which conductivity is applied by dispersing the conductive or semiconductive inorganic material of the above-mentioned metal oxide or compound metal oxide or the like in the conductive resin or nonconductive resin may be acceptable.

It is preferable that the semiconductor layer 15 of a wide band-gap have a band-gap causing to emit light of a shorter wavelength area than blue light by applying an electric field. Specifically, a compound semiconductor of 2.0 eV or more band-gap can be used, and more preferably, a compound semiconductor of 2.5 eV or more band-gap can be used. It is preferable that such a semiconductor be one of the following: a 13^{th}-15^{th} group compound semiconductor such as AlN (band-gap: 5.7 eV), AlP (2.4 eV), AlAs (2.2 eV), GaN (3.4 eV), GaP (2.3 eV), and a mixed crystal thererof (e.g., AlGaN, AlGaP, AlGaAs, GalnN, Galn P, InGaAlN, InGaAlP), and a mixture thereof in which a partial segregation is allowed; a 12^{th}-16^{th} group compound semiconductor such as ZnO (3.2 eV), ZnS (3.7 eV), ZnSe (2.6 eV), ZnTe (2.3 eV), CdO (2.1 eV), CdS (2.5 eV), HgS (2.0 eV), and a mixed crystal thereof (e.g., ZnCdS, ZnCdSe, ZnCdTe, ZnSSe, ZnCdSSe, ZnCdSeTe), and a mixture thereof in which a partial segregation is allowed; a 2^{nd}-16^{th} group compound semiconductor such as BeSe (3.8 eV), BeTe (3.4 eV), MgS (4.5 eV), MgSe (3.6 eV), MgTe (3.2 eV), and a mixed crystal thereof (e.g., ZnMgSSe, ZnMgBeSe), and a mixture thereof in which partial segregation is allowed; Al2^{th}-13^{th}-16^{th} group compound semiconductor such as (Zn, Cd)-(Al, Ga, In)-(O, S, Se) including ZnGa₂O₄(4.4 eV) as another example of a ternary compound, and a mixed crystal thereof, and a mixture thereof in which a partial segregation is allowed; an 11^{th}-13^{th}-16^{th} group compound semiconductor such as CuAlS₂ (3.5 eV), CuAlSe₂ (2.7 eV), CuAlTe₂ (2.1 eV), CuGaS₂ (2.4 eV), AgAlS₂ (3.1 eV), AgAlSe₂ (2.6 eV), AgAlTe₂ (2.3 eV) and AgGaS₂ (2.7 eV), and a mixed crystal thereof, and a mixture thereof in which a partial segregation is allowed; and a 12^{th}-14^{th}-15^{th} group compound semiconductor such as ZnSiP₂ (3.0 eV), ZnSiAs₂ (2.1 eV), ZnGeP₂ (2.3 eV), and CdSiP₂ (2.5 eV), and a mixed crystal thereof, and a mixture thereof in which a partial segregation is allowed. Note that the above-described compounds are exemplary given, and the present invention is not limited to these. Further, the band-gap may be adjusted by doping one or plural kinds of impurity elements serving as donors or accepters in these compound semiconductors. For example, they are selected from: metallic or non-metallic elements such as Li, Na, Cu, Ag, Au, Be, Mg, Zn, Cd, B, Al, Ga, In, C, Si, Ge, Sn, Pb, N, P, As, O, S, Se, Te, F, Cl, Br, I, Ti, Cr, Mn, Fe, Co and Ni; rear earth elements such as Ce, Pr, Nd, Sm, Eu, Gd, Tb, Dy, Ho, Er and Tm; fluoride such as TbF₃ and PrF₃; oxide such as ZnO and CdO.

Further, the phosphor layer 16 may be: a 2^{nd}-16^{th} group compound phosphor material such as CaS, SrS, CaSe or SrSe including the above described CaS:Eu, a 12^{th}-16^{th} group compound phosphor material such as ZnS, CdS, ZnSe, CdSe, or ZnTe, a mixed crystal of the above-mentioned compounds such as ZnMgS, CaSSe or CaSrS, or a mixture thereof in which a partial segregation is allowed, a thiogallate phosphor material such as CaGa₂S₄, SrGa₂S₄ or BaGa₂S₄, a thioaluminate phosphor material such as CaAl₂S₄, SrAl₂S₄ or BaAl₂S₄, a metallic oxide phosphor material such as Ga₂O₃, Y₂O₃, CaO, GeO₂, SnO₂ or ZnO, and a polyoxide phosphor material such as Zn₂SiO₄, Zn₂GeO₄, ZnGa₂O₄, CaGa₂O₄, CaGeO₃, MgGeO₃, Y₄GeO₈, Y₂GeO₅, Y₂Ge₂O₇, Y₂SiO₅, BeGa₂O₄, Sr₃Ga₂O₆, (Zn₂SiO₄—Zn₂GeO₄), (Ga₂O₃—Al₂O₃), (CaO—Ga₂O₃) and (Y₂O₃—GeO₂). In these phosphor materials, at least one kind of element selected from the group including Mn, Cu, Ti, Cr, Fe, Ni, Ag, Au, Al, Ga, Sn, Pb, Ce, Pr, Nd, Sm, Eu, Gd, Tb, Dy, Ho, Er, Tm and Yb may be activated as an activator agent. The activator agent may be a nonmetallic element such as Cl or I, or fluoride such as TbF₃ or PrF₃, or more than two kinds thereof may be activated together. There is no limitation provided that a phosphor is one used for EL element.

As described above, according to the electroluminescent element of the present embodiment, a wide band-gap semiconductor performs a ultraviolet range emission or blue light emission with a low voltage, and the phosphor particles are excited by the short wavelength light thereof, whereby the phosphor layer emits light as a whole, so high brightness and high luminous efficiency can be obtained. Further, since the matrix material is a transparent conductor, the flow of electrons is continued, whereby a low voltage drive (low power consumption) and a long lifetime are realized. Further, since an increase in size is easily realized, an effect of low cost is also achieved.

### Embodiment 2

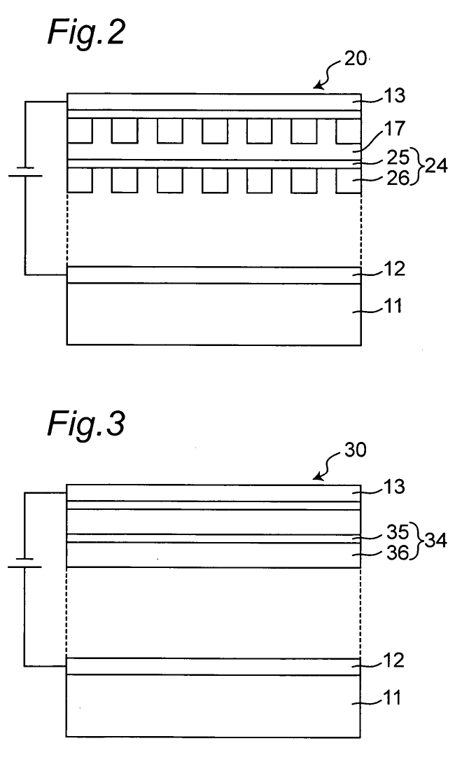

An electroluminescent element 20 according to an embodiment 2 of the present invention will be described by using FIG. 2. Comparing with the electroluminescent element of the embodiment 1, the electroluminescent element 20 is different in that a semiconductor layer 25 of a wide band-gap constituting a phosphor layer 24 is a continuous layer.

### Embodiment 3

An electroluminescent element 30 according to an embodiment 3 will be described by using FIG. 3. Comparing with the electroluminescent element of the embodiment 1, the electroluminescent element 30 is different in that both of a semiconductor layer 35 of a wide band-gap and a phosphor layer 36 constituting a phosphor layer 34 are continuous layers.

### Embodiment 4

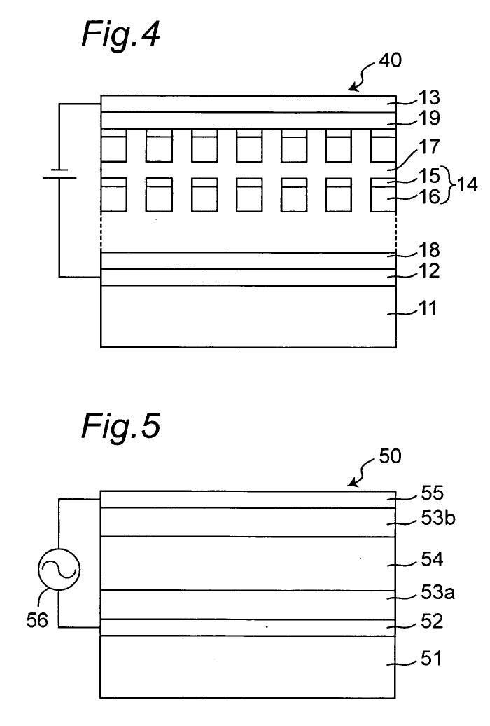

An electroluminescent element 40 according to an embodiment 4 will be described by using FIG. 4. Comparing with the electroluminescent element of the embodiment 1, the electroluminescent element 40 is different in that an electron transport layer 18 is further provided between the phosphor layer 14 and the positive electrode 12, and an electron transport layer 19 is further provided between the phosphor layer 14 and the negative electrode 13. These electron transport layers are capable of improving the flow of electrons in the phosphor layer.

The electron transport layers 18, 19, may consist of, in particular, a metal complex of 8-hydroxyquinoline such as tris(8-quinolinolato)aluminum (Alq3), or an amorphous material such as 5,5′-bis(dimesitylboryl)-2,2′bithiophene (BMB-2T) of a thiophene compound. Further, other preferred examples of low-molecular materials includes oxadiazole derivative, triazole derivative, 1,10-phenanthroline derivative, fluorene derivative, quinone derivative, styrylbenzene derivative, silole derivative, and their dimmer and trimer. Among others, the following materials are included: 2-(4-biphenyl)-5-(4-tert-butylphenyl)-1,3,4-oxadiazole (PBD), 2,5-bis(1-naphthyl)-1,3,4-oxadiazole (BND), 2,5-bis[1-(3-methoxy)-phenyl]-1,3,4-oxadiazole (BMD), 1,3,5-tris[5-(4-tert-butylphenyl)-1,3,4-oxadiazole-2-il]benzene (TPOB), 3-(4-biphenyl)-4-phenyl-5-(4-tert-butylphenyl)-1,2,4-triazole (TAZ), 3-(4-biphenyl)-4-(4-ethylphenyl)-5-(4-tert-butylphenyl)-1,2,4-triazole(p-EtTAZ), 4,7-diphenyl-1,10-phenanthroline (BPhen), 2,9-dimethyl-4,7-diphenyl-1,10-phenanthroline (BCP), 3,5-dimethyl-3′,5′-di-tert-butyl-4,4′-diphenoquinone (MBDQ), 2,5-bis[2-(5-tert-butylbenzoxazolyl)]-thiophene (BBOT), trinitrofluorenone (TNF). Further, high-molecular materials include the above-mentioned CN-PPV, polyquinoxaline, and polymer in which a molecular structure showing the electron transportation ability with low molecular system is incorporated in a molecular chain. A single type or a mixture of plural types thereof may be acceptable, but the present invention is not limited to these. Further, a single crystal or a polycrystal of inorganic material such as an n-type compound semiconductor or an n-type oxide semiconductor, and resin dispersed layer of their particle powder may be used. Note that the electron transport layer 18 provided on the positive electrode 12 side also serves as a hole block layer.

Although the case of applying a DC voltage between the electrodes 12 and 13 has been explained in the embodiments 1 to 4 described above, the present invention is not limited to this configuration. An AC voltage or a pulse voltage may be applied.

Further, in the embodiments 1 to 4, a luminescent light extracted from the luminescent element is determined by the semiconductor layer 15 and the phosphor layer 16 constituting the phosphor layer 14. For a multiple display, a white display and an adjustment of color purity of each RGB color, a color conversion layer may be provided in front of the phosphor layer 14 in a light extracting direction, or a color conversion material may be mixed in the transparent conductive layer 17. As the color conversion layer and the color conversion material, those emitting light by using light as the excitation source may be used, including well-known phosphors, pigments, dyes and the like, whether organic materials or inorganic materials. In the case of inorganic materials, materials used as phosphor layer 16 described above can be used. As organic materials, a polycyclic aromatic hydrocarbon compound such as naphthalene, perylene, rubrene, anthracene, pyrene, naphthacene and a derivative thereof, and hetero aromatic compounds such as coumarin, quinoline, oxadiazole, lophine, nile red, 4H-pyranilidenepropanedinitrile and phenoxazone, and a derivative thereof are used. Further, as other luminescent materials, there are used: a polymethine compound such as cyanine, oxole, azulenium or pyrylium, a styrylbenzene compound such as bis-(diphenylvynil)biphenyl, a porphyrin compound such as chlorophyll, a chelate metal complex such as an aluminum quinolinol complex, a zinc hydroxyphenyloxazole complex, a zinc hydroxyphenylthiazole complex, or an azomethine metal complex, chelate lanthanoid complex, a xanthene compound such as phenolphthalein, Malachite green, fluorescein, Rhodamine B or Rhodamine 6G, quinacridone, diketopyrrolopyrrole, magnesium phthalocyanine, or a derivative thereof, but the present invention is not limited to these materials.

Further, the electroluminescent element according to the embodiments 1 to 4 may be manufactured by means of a ceramic forming method such as doctor blade method, hot pressing, HIP and sol-gel process, a thin film forming method such as vapor deposition, sputtering, ion plating and molecular beam epitaxial (MBE) method, a thin film processing method such as wet etching and ion etching, or spin coating, an ink jet method, or the like.

### Embodiment 5

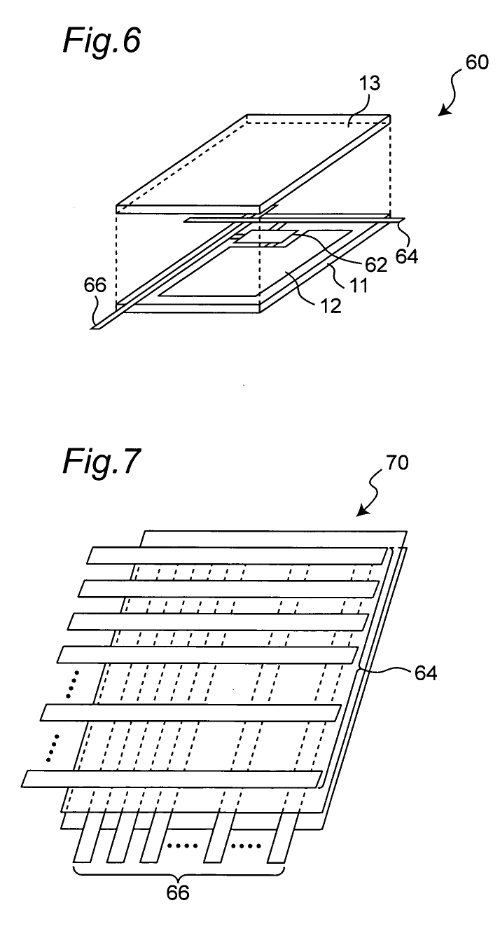

An electroluminescent element 60 according to an embodiment 5 of the present invention will be explained by using FIG. 6. FIG. 6 is a perspective view showing the electrode structure of the electroluminescent element 60. The luminescent element 60 further includes a thin film transistor 62 connected to the positive electrode 12 of the electroluminescent element 10 according to the embodiment 1. The thin film transistor 62 is connected with an x electrode 64 and a y electrode 66. Since the semiconductor layer 15 of a wide band-gap and the phosphor layer 16 are laminated in an adjacent manner in the luminescent element 60, the phosphor layer 16 can be excited by blue light emission or ultraviolet region emission of the semiconductor layer 15 even with a low voltage drive. Therefore, the thin film transistor 62 can be used. Further, by using the thin film transistor 62, it is possible to cause the electroluminescent element 60 to have a memory function. As such a thin film transistor 62, a low temperature polysilicon or amorphous silicon thin film transistor or the like is used. Further, an organic thin film transistor formed of a thin film including an organic material may be used.

### Embodiment 6

A display device according to an embodiment 6 of the present invention will be described by using FIG. 7. FIG. 7 is a schematic plan view showing an active matrix formed of the x electrodes 64 and the y electrodes 66, orthogonal to each other, of the display device 70. The display device 70 is an active matrix type display device having thin film transistors. The active matrix type display device 70 includes: a luminescent array in which a plurality of electroluminescent elements 60 having the thin film transistors 62 shown in FIG. 6 are arranged in two dimensions; a plurality of x electrodes extending, in parallel with each other, in a first direction in parallel with the face of the electroluminescent array; and a plurality of y electrodes 66 extending in parallel with a second direction which is in parallel with the face of the luminescent array and orthogonal to the first direction. The thin film transistor 62 of the luminescent array is connected with both the x electrode 64 and the y electrode 66, respectively. A luminescent element defined by a pair of x electrode 64 and y electrode 66 forms one pixel. According to the active matrix display device 70, the phosphor layer 16 constituting the luminescent element of each pixel is laminated while being adjacent to the semiconductor layer 15 having a wide band-gap, as described above. Thereby, it is possible to cause blue light emission and ultraviolet light emission by the semiconductor 15 having a wide band-gap even with a low voltage drive, so as to cause the phosphor layer 16 to emit light. In this way, since a low voltage drive is possible, it is possible to use thin film transistors 62 and to utilize memory effect. Further, since it is driven with a low voltage, a display device of long lifetime can be obtained. Further, in the case of a color display device, the phosphor layer may be deposited by dividing it for each RGB color. Alternatively, a luminescent unit for each color of RGB held between electrodes may be laminated. Further, in the case of another example of a color display device, it is possible to display each color or RGB by using a color filter and/or color conversion filter after forming a display device with phosphor layer of a single color or two colors.

### Embodiment 7

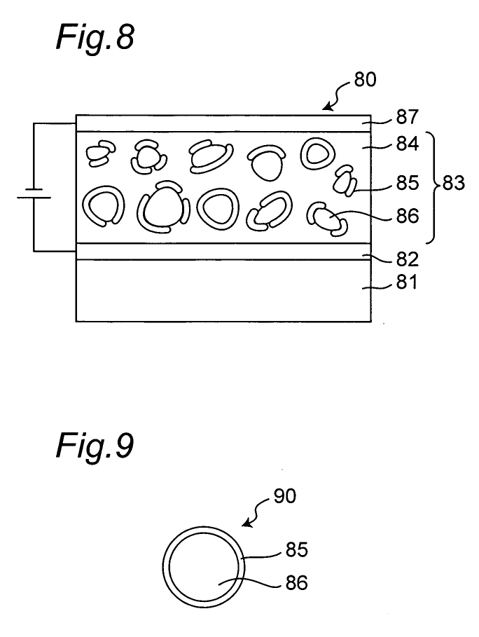

An electroluminescent electrode 80 according to an embodiment 7 of the present invention will be explained by using FIG. 8. FIG. 8 is a cross-sectional view showing the structure of the electroluminescent element 80. The electroluminescent element 80 has a multilayer structure, and has a pair of positive electrode 82 and negative electrode 87, facing each other, and a phosphor layer 83 formed between the positive electrode 82 and the negative electrode 87, on the substrate 81. A low voltage of several V to several tens V is applied between the positive electrode 82 and the negative electrode 87 by a DC source. Further, the positive electrode 82 is a transparent electrode, and an emission from a phosphor layer 83 is extracted from the side of the positive electrode 82.

Further, the phosphor layer 83 is formed on the positive electrode 82. The phosphor layer 83 is so configured that phosphor particles 86 are dispersed in the matrix material consisting of transparent conductor 84. It is preferable that at least a part of the surface of the phosphor particle be covered with a semiconductor 85 of a wide band-gap, or chemisorption be performed. Further, as shown in FIG. 9, it is more preferable that substantially all surface of the phosphor particle 86 be covered with the semiconductor 85. By covering substantially all surfaces in this way, a large effect in moisture proof of the phosphor particle 86 is achieved. Note that the transparent conductor 84, the phosphor particle 86, and the semiconductor 85 for covering the phosphor particle 86 constituting the electroluminescent element 80 are substantially same as the transparent conductor 17, the phosphor layer 16 and the semiconductor layer 15 constituting the electroluminescent element 10 according to the embodiment 1, respectively, so the detailed explanation is omitted. Further, other constituting members of the electroluminescent element 80 are substantially same as those of the electroluminescent element 10 according to the embodiment 1, so the detailed explanation is omitted.

As described above, according to the electroluminescent element of the present embodiment, a semiconductor of a wide band-gap performs ultraviolet range emission and blue light emission with a low voltage, and the phosphor particles are excited by the short wavelength light thereof, whereby the phosphor layer emits light as a whole. Therefore, high brightness and high luminous efficiency can be obtained. Further, since the matrix material is a transparent conductor, the flow of electrons continues, and a low voltage drive (low power consumption) and a long lifetime are realized. Further, since an increase in size is easily realized, an effect of low cost is also achieved.

### Embodiment 8

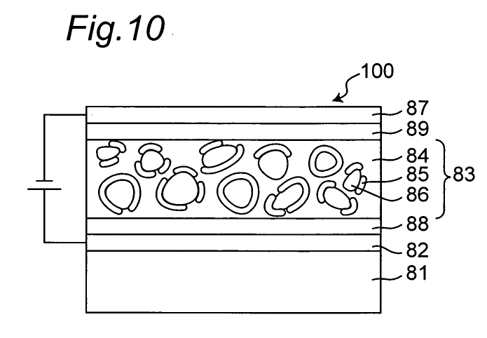

An electroluminescent element 100 according to an embodiment 8 of the present invention will be explained by using FIG. 10. FIG. 10 is a cross-sectional view showing the structure of the electroluminescent element. Comparing with the electroluminescent element 80 of the embodiment 7, the electroluminescent element 100 is different in that an electron transport layer 88 is provided between the phosphor layer 83 and the positive electrode 82 and an electron transport layer 89 is provided between the phosphor layer 83 and the negative electrode 87. The electron transport layers 88, 89 are provided to improve the flow of electrons in the phosphor layer 83. Note that the electron transport layers 88, 89 constituting the electroluminescent element 100 are substantially same as the electron transport layers 18, 19 constituting the electroluminescent element 40 of the embodiment 4, so the detailed explanation is omitted.

Although explanation has been given for the case of applying a DC voltage between the electrodes 82 and 87 in the embodiments 7 and 8, the present invention is not limited to this configuration. An AC voltage or a pulse voltage may be applied.

Further, an electroluminescent elements according to the embodiments 7 and 8 may be manufactured by means of a ceramic forming method such as doctor blade method, hot pressing, HIP or sol-gel process, a thin film forming method such as vapor deposition, sputtering, ion plating or molecular beam epitaxial (MBE) method, spin coating, an ink jet method, or the like.

### Embodiment 9

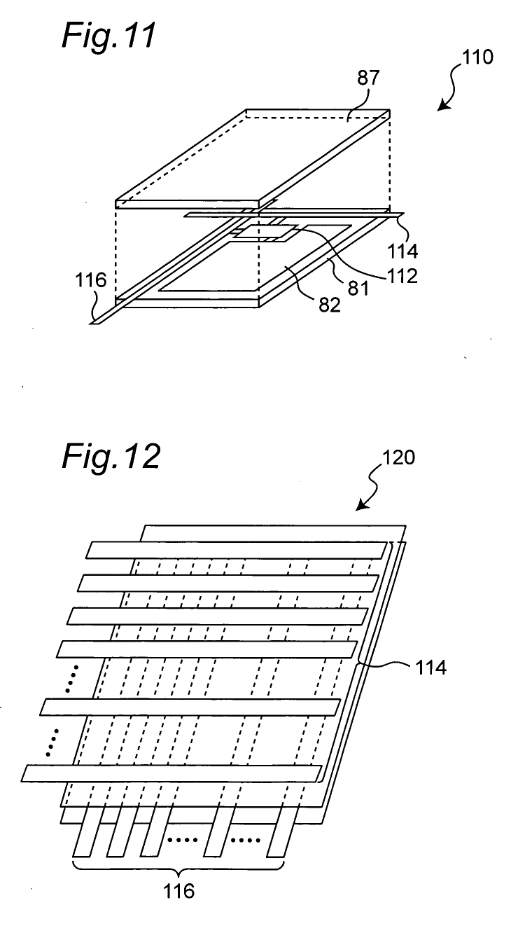

An electroluminescent element 110 according to an embodiment 9 of the present invention will be explained by using FIG. 11. FIG. 11 is a perspective view showing the electrode structure of the electroluminescent element 110. The electroluminescent element 110 is further include a thin film transistor 112 connected with the positive electrode 82 of the electroluminescent element 80 of the embodiment 7. The thin film transistor 112 is connected with an x electrode 114 and a y electrode 116. In the luminescent element 110, the phosphor particle 86 is covered with the semiconductor 85 of a wide band-gap, so it is possible to drive with a low voltage. Therefore, the thin film transistor 112 can be used. Further, by using the thin film transistor 112, it is possible to provide a memory function to the electroluminescent element 110. As for the thin film transistor 112, a low temperature polysilicon or amorphous silicon thin film transistor may be used. Further, the thin film transistor 112 may be an organic thin film transistor consisting of a thin film including an organic material.

### Embodiment 10

A display device 120 according to an embodiment 10 of the present invention will be explained by using FIG. 12. FIG. 12 is a schematic plan view showing an active matrix composed of the x electrodes 114 and the y electrodes 116, orthogonal to each other, of the display device 120. The display device 120 is an active matrix type display device having thin film transistors. The active matrix type display device 120 includes: a luminescent array in which a plurality of electroluminescent elements 110 having thin film transistors 112 shown in FIG. 11 are arranged in two dimensions; a plurality of x electrodes 114, in parallel with each other, extending in a first direction in parallel with the face of the electroluminescent array; and a plurality of y electrodes extending in parallel with a second direction, orthogonal to the first direction, in parallel with the face of the luminescent array. The thin film transistor 112 of the luminescent array is connected with the x electrode 114 and the y electrode 116, respectively. A luminescent element defined by a pair of x electrode 114 and y electrode forms one pixel. According to the active matrix display device 120, the phosphor particles 86, in each of which the surface is covered with the semiconductor 85 of a wide band-gap, are dispersed in the matrix material of the transparent conductor 84 on the surface of the phosphor layer 83 constituting the luminescent element of each pixel, as described above. Thereby, it is possible to cause the blue light emission or ultraviolet light excitation of the semiconductor 85 having a wide band-gap even with a low voltage drive so as to make the phosphor particles 86 emit light. In this way, since a low voltage drive is possible, it is possible to use thin film transistors 62 and to utilize memory effect. Further, since it is driven with a low voltage, a display device of long lifetime can be obtained. Further, in the case of a color display device, the phosphor layer may be deposited by dividing it for each RGB color. Alternatively, a luminescent unit for each RGB color held between the electrodes may be laminated. Further, in the case of another example of a color display device, it is possible to display each color of RGB by using a color filter and/or color conversion filter after forming a display device with phosphor layer of a single color or two colors.

### Embodiment 11

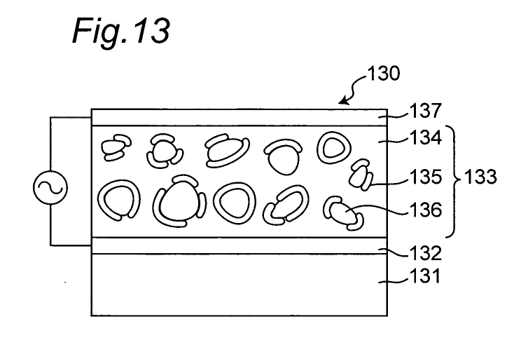

An electroluminescent element 130 according to an embodiment 11 of the present invention will be explained by using FIG. 13. FIG. 13 is a cross-sectional view showing the structure of the electroluminescent element 130. The electroluminescent element 130 has a multilayer structure, and has a pair of first electrode 132 and second electrode 137 facing each other, and a phosphor layer 133 formed between the first electrode 132 and the second electrode 137, on the substrate 131. A voltage of several tens V is applied between the first electrode 132 and the second electrode 137 by a AC source.

Further, the phosphor layer 133 is one in which phosphor particles 136 are dispersed in the matrix material formed of a transparent conductor 134. It is preferable that at least a part of the surface of the phosphor particle 136 be covered with a semiconductor 135 with a wide band-gap, or chemisorption be performed. Further, it is more preferable that substantially all surface of the phosphor particle 136 be covered with the semiconductor 135. By covering substantially all surface in this way, a large effect in moisture proof of the phosphor particle 136 is achieved.

Further, as the transparent conductor 134 constituting the electroluminescent element 130, transparent conductive resin can be used. The transparent conductive resin has less conductivity comparing with ITO, InZnO, tin oxide which are examples of the transparent conductive layer body layer 17 and the transparent conductor 84 described above, but defectives such as pinholes are less caused, so it is preferable in pressure resistance. A stable element characteristic can be obtained even applying several tens V to hundred and several tens V. Preferable examples as the transparent conductive resin materials are substantially same as materials used for the transparent conductive layer 17 of the electroluminescent element 10 according to the embodiment 1, so the detailed explanation thereof is omitted. Further, other constitutional members of the electroluminescent element 130 are substantially same as those of the electroluminescent element 80 according to the embodiment 7, respectively, so the detailed explanation is omitted. In the configuration of the electroluminescent element 130, the first electrode 132 is a transparent electrode and light is extracted from the side of the first electrode 132.

As described above, according to the electroluminescent element of the present embodiment, a semiconductor of a wide band-gap performs ultraviolet range emission or blue light emission, and the phosphor particles are excited by the short wavelength light thereof, so the phosphor layer emits light as a whole. Therefore, a high brightness and high luminous efficiency can be obtained. Further, an increase in size is easily realized, so an effect of low cost can be achieved.

### Embodiment 12

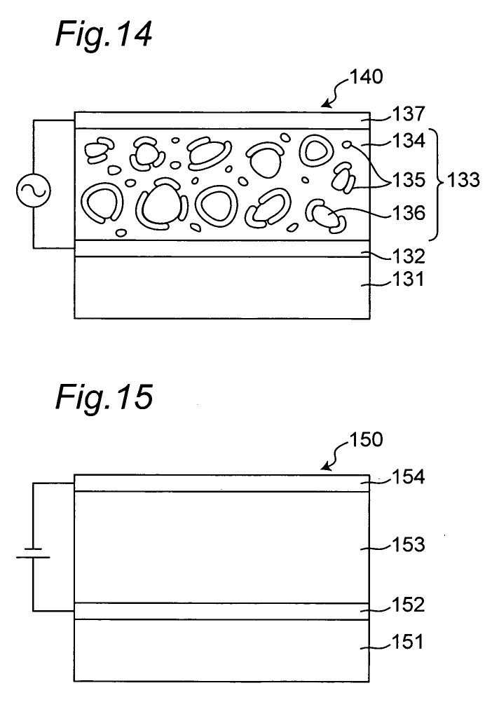

An electroluminescent element 140 according to an embodiment 12 of the present invention will be explained by using FIG. 14. FIG. 14 is a cross-sectional view showing the structure of the electroluminescent element 140. Comparing with the electroluminescent element 130 according to the embodiment 11, the electroluminescent element 140 is different in that fine particles 138 consisting of semiconductors having a wide band-gap are further dispersed in the matrix material. Therefore, similar to the embodiments described above, it is possible to provide an electroluminescent element of high brightness and high luminous efficiency. Further, since an increase in size is easily realized, an effect of low cost is also achieved. Note that in the phosphor layer 133, a phosphor particle 136 in which at least a part of the surface is covered with the semiconductor 135 of a wide band-gap may be included together. Further, respective constitutional members of the electroluminescent element 140 are substantially same as those of the electroluminescent element 130 of the embodiment 11, so detailed explanation is omitted.

Although the case of applying an AC voltage between the electrodes 132 and 137 has been described in the embodiments 11 and 12 described above, the present invention is not limited to this. A DC voltage or a pulse voltage may be applied.

Further, the electroluminescent elements according to the embodiments 11 and 12 described above may be manufactured by means of a ceramic forming method such as doctor blade method, hot pressing, HIP or sol-gel process, a thin film forming method such as vapor deposition, sputtering, ion plating or molecular beam epitaxial (MBE) method, spin coating, an ink jet method, or the like.

### Embodiment 13

An electroluminescent element 150 according to an embodiment 13 of the present invention will be explained by using FIG. 15. FIG. 15 is a cross-sectional view showing the structure of the electroluminescent element 150. The electroluminescent element 150 has a multilayer structure, and has a pair of positive electrode 152 and negative electrode 154 facing each other, and a phosphor layer 153 formed between the positive electrode 152 and the negative electrode 154, on the substrate 151. A low voltage of several V to several tens V is applied between the positive electrode 152 and the negative electrode 156 by a DC source. Further, the positive electrode 152 is a transparent electrode, and light emitted from the phosphor layer 153 is extracted from the side of the positive electrode 152.

Further, the phosphor layer 153 is formed of a phosphor material and a semiconductor material of a wide band-gap, and is deposited by co-vapor-deposition. Therefore, it is possible to provide an electroluminescent element of high brightness and high luminescent efficacy, similar to the embodiments described above. Further, since an increase in size is easily realized, an effect of low cost is also achieved. Respective constitutional members of the electroluminescent element 150 are substantially same as those of the electroluminescent element 10 according to the embodiment 1, so detailed explanation is omitted.

Although explanation has been given for the case of applying a DC voltage between the electrodes 152 and 154 in the embodiment 13, the present invention is not limited to this configuration. An AC voltage or a pulse voltage may be applied.

Further, in the embodiments 7, 8 and 11 to 13, the luminescent light extracted from the luminescent element is determined by the phosphor materials and semiconductor materials in the phosphor layers 83, 133 and 153. However, for a multiple display, a white display and an adjustment of color purity of each RGB color, a color conversion layer may be provided in front of the phosphor layer in a light extracting direction, or a color conversion material may be mixed in the phosphor layer.

As described above, the present invention is explained in detail by way of the preferred embodiments. However, the present invention is not limited to these embodiments, and it is obvious for those skilled in the art that various preferable deformations and modifications are possible within the technical range of the present invention described in the scope of claims below.

1. An electroluminescent element comprising:
a pair of electrodes facing each other; and
at least one phosphor layer formed between the pair of electrodes, wherein the phosphor layer includes a phosphor semiconductor with a wide band-gap.

2. The electroluminescent element according to claim 1, wherein the phosphor layer has a laminated structure of a phosphor layer and a semiconductor layer with wide band-gap.

3. The electroluminescent element according to claim 2, further comprising at least one transparent conductive layer interposed between the pair of electrodes.

4. The electroluminescent element according to claim 3, wherein the transparent conductive layer is a partially discontinuous layer.

5. The electroluminescent element according to claim 2, wherein at least one of the phosphor layer and the semiconductor layer constituting the phosphor layer is a partially discontinuous layer.

6. The electroluminescent element according to claim 1, wherein the phosphor layer includes a phosphor particle in each of which at least a part of a surface thereof is covered with a semiconductor having a wide band-gap.

7. The electroluminescent element according to claim 1, wherein the phosphor layer includes a phosphor particle in each of which substantially all surface thereof is covered with a semiconductor having wide band-gap.

8. The electroluminescent element according to claim 6, wherein the phosphor layer is so configured that the phosphor particles, in each of which at least a part of a surface thereof is covered with a semiconductor having wide band-gap, are dispersed in a matrix material.

9. The electroluminescent element according to claim 7, wherein the phosphor layer is so configured that the phosphor particles, in each of which substantially all surface thereof is covered with a semiconductor having a wide band-gap, are dispersed within a matrix material.

10. The electroluminescent element according to claim 8, wherein the matrix material is a transparent conductor.

11. The electroluminescent element according to claim 1, wherein the semiconductor constituting the phosphor layer has a band-gap causing to emit light of a shorter wavelength than blue light by applying an electric field.

12. The electroluminescent element according to claim 1, wherein the semiconductor constituting the phosphor layer has a band-gap of 2.0 eV or more.

13. The electroluminescent element according to claim 1, wherein the semiconductor constituting the phosphor layer has a band-gap of 2.5 eV or more.

14. The electroluminescent element according to claim 12, wherein the semiconductor is so configured that a main component thereof is a 13^{th}-15^{th} group compound semiconductor, a mixed crystal thereof, or a mixture thereof in which a partial segregation is allowed.

15. The electroluminescent element according to claim 12, wherein the semiconductor is so configured that a main component thereof is a 12^{th}-16^{th} group compound semiconductor, a mixed crystal thereof, or a mixture thereof in which a partial segregation is allowed.

16. The electroluminescent element according to claim 12, wherein the semiconductor is so configured that a main component thereof is a 2^{nd}-16^{th} group compound semiconductor, a mixed crystal thereof, or a mixture thereof in which a partial segregation is allowed.

17. The electroluminescent element according to claim 12, wherein the semiconductor is so configured that a main component thereof is a 12^{th}-13^{th}-16^{th} group compound semiconductor, a mixed crystal thereof, or a mixture thereof in which a partial segregation is allowed.

18. The electroluminescent element according to claim 12, wherein the semiconductor is so configured that a main component thereof is a 11^{th}-13^{th}-16^{th} group compound semiconductor, a mixed crystal thereof, or a mixture thereof in which a partial segregation is allowed.

19. The electroluminescent element according to claim 12, wherein the semiconductor is so configured that a 12^{th}-14^{th}-15^{th} group compound semiconductor, a mixed crystal thereof, or a mixture thereof in which a partial segregation is allowed.

20. The electroluminescent element according to claim 1, further comprising an electron transport layer between the phosphor layer and at least one of the electrodes.

21. The electroluminescent element according to claim 2, wherein the pair of electrodes are positive electrode and negative electrode.

22-24. (canceled)

25. The electroluminescent element according to claim 6, wherein the pair of electrodes are positive electrode and negative electrode.

26. The electroluminescent element according to claim 21, wherein at least one semiconductor layer constituting the phosphor layer is located nearer the negative electrode side than the phosphor layer.

27. The electroluminescent element according to claim 1, further comprising a thin film transistor connected with one of the pair of electrodes.

28. A display device comprising:
an electroluminescent array in which electroluminescent elements are arranged in two dimensions, wherein each electroluminescent element comprises:
a pair of electrodes facing each other;
at least one phosphor layer formed between the pair of electrodes, wherein the phosphor layer includes a phosphor semiconductor with wide band-gap; and
a thin film transistor connected with one of the pair of electrodes;
a plurality of x electrodes, in parallel with each other, extending in a first direction in parallel with a face of the electroluminescent array; and
a plurality of y electrodes extending in parallel with a second direction, orthogonal to the first direction, in parallel with the face of the electroluminescent array, wherein the thin film transistor of the electroluminescent array is connected with the x electrode and the y electrode, respectively.
